(19) United States
(12) Patent Application Publication
(10) Pub. No.: US 2025/0350204 A1
(43) Pub. Date: Nov. 13, 2025

(54) POWER SUPPLY DEVICE

(71) Applicant: Samsung Electronics Co., Ltd., Suwon-si (KR)

(72) Inventors: Chenghao Jin, Suwon-si (KR); Suin Kim, Suwon-si (KR); Seonmee Lee, Suwon-si (KR)

(21) Appl. No.: 18/972,391

(22) Filed: Dec. 6, 2024

(30) Foreign Application Priority Data
May 7, 2024 (KR) 10-2024-0059651

(51) Int. Cl. H02M 3/158; H02M 1/00

(52) U.S. Cl. CPC H02M 3/158; H02M 1/0019; H02M 1/0067

(57) ABSTRACT

A power supply device includes a voltage conversion circuit including at least one switch device operating in response to a control signal, and the voltage conversion circuit receives an input voltage and generates an output voltage, higher or lower than an input voltage, depending on a duty ratio of the control signal, and a controller changing the duty ratio of the control signal to adjust a level of the output voltage. The controller includes a load sensor detecting a sensing current from the at least one switch device, and a current compensation unit applying a compensation current to the sensing current input to the load sensor during a transition period in which the output voltage changes from a first level to a second level.

### CROSS-REFERENCE TO RELATED APPLICATION(S)

This application claims benefit of priority to Korean Patent Application No. 10-2024-0059651 filed on May 7, 2024 in the Korean Intellectual Property Office, the disclosure of which is incorporated herein by reference in its entirety.

### BACKGROUND

The present inventive concept relates to a power supply device.

A semiconductor device may include a power supply device generating a power voltage required for an operation thereof using an external power voltage supplied from an external source. For example, the power supply device may use the external power voltage as an input voltage, to generate an output voltage having a level, higher or lower than a level of the input voltage. The power supply device may support a function of increasing or decreasing the output voltage to respond to various applications, but in a period in which the output voltage increases or decreases, it may be mistakenly determined that a load connected to the power supply device has changed, to cause malfunctioning of the power supply device.

### SUMMARY

An aspect of the present inventive concept is to reflect a compensation current in a sensing current in a transition period in which an output voltage of a power supply device increases or decreases, to effectively prevent a malfunction that may occur in the power supply device by an increase or decrease of the sensing current due to a change in output voltage, even in the case that a load does not change in the transition period.

According to an aspect of the present inventive concept, a power supply device may include a voltage conversion circuit including at least one switch device operating in response to a control signal, and configured to receive an input voltage and generate an output voltage, higher or lower than the input voltage, depending on a duty ratio of the control signal, and a controller configured to change the duty ratio of the control signal to adjust a level of the output voltage. The controller includes a load sensor detecting a sensing current from the at least one switch device included in the voltage conversion circuit, and a current compensation unit applying a compensation current to the sensing current input to the load sensor during a transition period in which the output voltage changes from a first level to a second level.

According to an aspect of the present inventive concept, a power supply device includes a voltage conversion circuit including an input terminal, an output terminal, and at least one switch device configured to operate in response to a control signal, and configured to receive an input voltage through the input terminal and configured to output an output voltage through the output terminal, and a controller configured to generate the control signal, and configured to detect a sensing current from a load connected to the output terminal of the voltage conversion circuit. The controller generates a compensation current based on a slew rate of the output voltage and effective capacitance of an output capacitor connected to the output terminal of the voltage conversion circuit during a transition period in which a level of the output voltage is adjusted, and applies the compensation current to the sensing current.

According to an aspect of the present inventive concept, a power supply device includes a voltage conversion circuit including an inductor, at least one switch device and an output capacitor, and a controller configured to activate the at least one switch device in response to a control signal, and configured to detect a sensing current from the voltage conversion circuit to determine a change in load receiving an output voltage of the voltage conversion circuit. The controller subtracts a first compensation current from the sensing current when a current flowing the inductor increases without the change in load, and adds a second compensation current to the sensing current when the current flowing the inductor decreases without the change in load.

### BRIEF DESCRIPTION OF DRAWINGS

The above and other aspects, features, and advantages of the present inventive concept will be more clearly understood from the following detailed description, taken in conjunction with the accompanying drawings, in which:

FIG. 1 is a block diagram illustrating a power supply device according to an embodiment.

FIGS. 2 and 3 are views illustrating an electronic device including a power supply device according to an embodiment.

FIGS. 4 to 6 are circuit diagrams illustrating a DC-DC converter included in a power supply device according to an embodiment.

FIGS. 7A and 7B are equivalent circuit diagrams illustrating an operation of a DC-DC converter included in a power supply device according to an embodiment.

FIG. 8 is a graph illustrating an operation of a DC-DC converter included in a power supply device according to an embodiment.

FIGS. 9A and 9B are views illustrating an operation of a power supply device according to an embodiment.

FIGS. 10A and 10B are views illustrating an operation of a power supply device according to an embodiment.

FIGS. 11 and 12 are views illustrating an operation of a power supply device according to an embodiment.

FIG. 13 is a block diagram illustrating a power supply device according to an embodiment.

FIGS. 14 and 16 are views illustrating an operation of a power supply device.

FIGS. 15 and 17 to 19 are views illustrating an operation of a power supply device according to example embodiments.

FIG. 20 is a view illustrating a power supply device according to an embodiment.

### DETAILED DESCRIPTION

Hereinafter, preferred embodiments of the present inventive concept will be described with reference to the attached drawings.

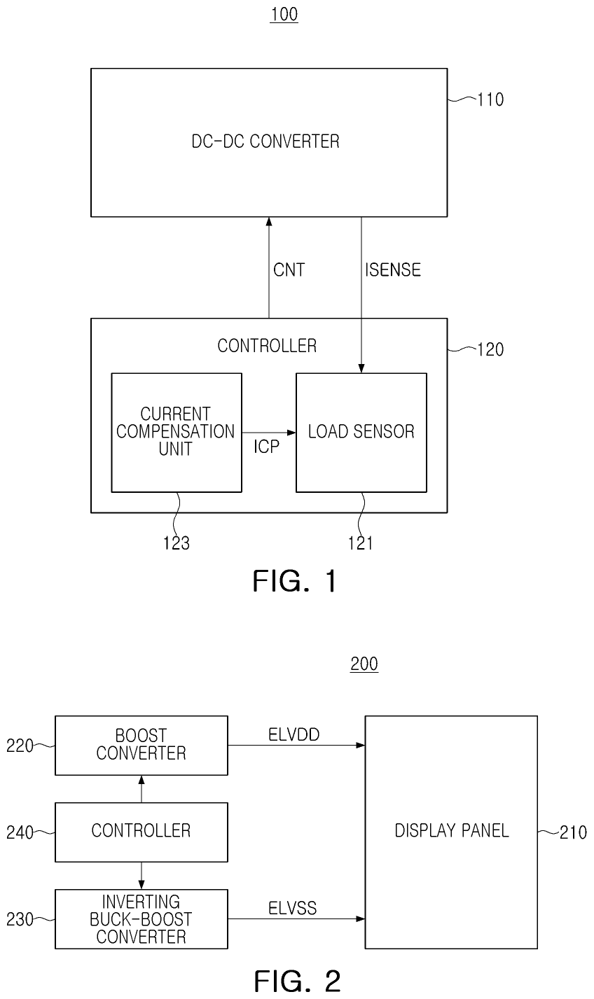

FIG. 1 is a block diagram illustrating a power supply device according to an embodiment.

Referring to FIG. 1, a power supply device 100 according to an embodiment may include a DC-DC converter 110 as a voltage conversion circuit, a controller 120, and the like. The DC-DC converter 110 may include a circuit such as a buck converter, a boost converter, a buck-boost converter, or the like, including at least one switch device. The DC-DC converter 110 may increase or decrease a level of an input voltage, which may be a direct current voltage, to output an output voltage. Depending on an embodiment, the power supply device 100 may include a low drop out (LDO) regulator as a voltage conversion circuit, instead of the DC-DC converter 110.

The controller 120 may output a control signal CNT controlling on/off switching of the switch device included in the DC-DC converter 110. In an embodiment, the control signal CNT may be a pulse width modulation (PWM) signal with a predetermined period.

The controller 120 may include a load sensor 121, a current compensation unit 123, and the like. The load sensor 121 may detect a sensing current ISENSE from an output terminal of the DC-DC converter 110, and may sense a change in load connected to the output terminal of the DC-DC converter 110, based on the sensing current ISENSE. For example, the controller 120 may detect the load connected to the DC-DC converter 110. For example, when it is determined that the load has increased based on the sensing current ISENSE, the controller 120 may change an operation mode of the DC-DC converter 110, or may execute an overcurrent protection operation for protecting the DC-DC converter 110.

The power supply device 100 according to an embodiment may support a dynamic voltage scaling (DVS) function that may adjust a level of the output voltage. In an embodiment, when the DVS function is activated, the power supply device 100 may adjust the level of the output voltage, regardless of a change in load connected to the output terminal of the DC-DC converter 110. For example, the controller 120 may change a duty ratio and/or a frequency of the control signal CNT output to the DC-DC converter 110, to increase or decrease the level of the output voltage of the DC-DC converter 110.

When the DVS function is activated, the controller 120 may increase or decrease the output current of the DC-DC converter 110 to increase or decrease the level of the output voltage. As the output current of the DC-DC converter 110 increases or decreases, the sensing current ISENSE detected by the load sensor 121 may be changed. Even in the case that there is no change in load connected to the output terminal of the DC-DC converter 110, the controller 120 may mistakenly determine that the load connected to the DC-DC converter 110 increases or decreases based on a change in the sensing current ISENSE, and may take follow-up action accordingly. Therefore, an unintended malfunction may occur in the power supply device 100.

In an embodiment, during a transition time when the DVS function is activated and the level of the output voltage increases or decreases, the current compensation unit 123 of the controller 120 may provide a compensation current ICP to the load sensor 121. The compensation current ICP may be reflected to the sensing current ISENSE that the load sensor 121 detects from the DC-DC converter 110. For example, a direction of the compensation current ICP, for example, whether the current compensation unit 123 adds the compensation current ICP to the sensing current ISENSE or draws a portion of the sensing current ISENSE as the compensation current ICP may be determined, depending on an increase or a decrease of the output voltage.

In this manner, a problem in which the load sensor 121 incorrectly senses a change in load connected to the DC-DC converter 110 may be minimized by reflecting the compensation current ICP to the sensing current ISENSE in the transition period in which the level of the output voltage is changed. Therefore, a malfunction of the power supply device 100 may be prevented, and reliability, power consumption, or the like of an electronic device including the power supply device 100 may be improved.

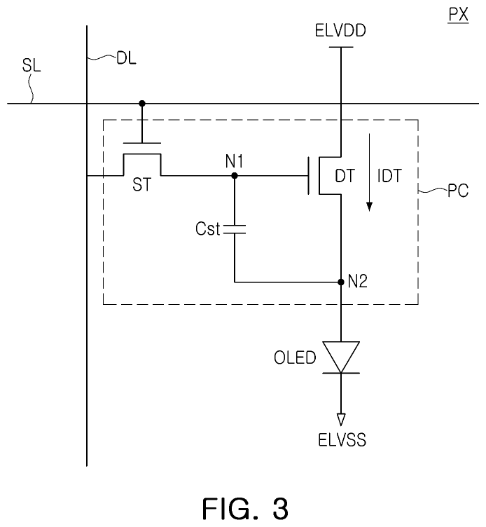

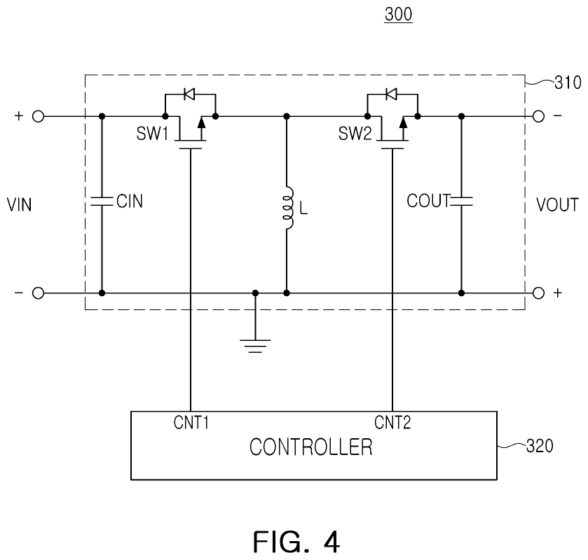

FIGS. 2 and 3 are views illustrating an electronic device including a power supply device according to an embodiment.

Referring to FIG. 2, an electronic device according to an embodiment may be a display device 200. The display device 200 may include a display panel 210, a boost converter 220 and an inverting buck-boost converter 230, supplying a power voltage required for the display panel 210, a controller 240, and the like.

In an embodiment illustrated in FIG. 2, the boost converter 220 may provide a first power voltage ELVDD to the display panel 210 using an input voltage supplied from a voltage source such as a battery or the like. The inverting buck-boost converter 230 may provide a second power voltage ELVSS to the display panel 210 using the input voltage supplied from the voltage source. For example, the first power voltage ELVDD from the boost converter 220 may be a positive voltage, and the second power voltage ELVSS output from the inverting buck-boost converter 230 may be a negative voltage.

The display panel 210 may include a plurality of pixels, and the plurality of pixels may be arranged along a plurality of scan lines and a plurality of data lines. Referring to FIG. 3 together, a plurality of pixels PX may include an organic light emitting diode (OLED) device emitting light, and a pixel circuit PC driving the OLED device, respectively. As illustrated in FIG. 3, the pixel circuit PC included in one pixel may be connected to one of the plurality of scan lines SL and one of the plurality of data lines DL.

Referring to FIG. 3, an anode electrode of the OLED device may be connected to the pixel circuit PC, and the second power voltage ELVSS may be supplied to a cathode electrode. In an embodiment, the cathode electrode of the OLED device included in each of the plurality of pixels PX may be connected to an output terminal of the inverting buck-boost converter 230 to receive the second power voltage ELVSS.

Brightness of the OLED device in each of the plurality of pixels PX may be changed, depending on a driving current IDT applied to the OLED device by the pixel circuit PC. For example, the pixel circuit PC may control the driving current IDT flowing between the first power voltage ELVDD and the second power voltage ELVSS through the OLED device in response to a data voltage applied to the data line DL.

The pixel circuit PC may include a select transistor ST, a driving transistor DT, a storage capacitor Cst, and the like. The select transistor ST may be connected between the data line DL and a first node N1, and a gate of the select transistor ST may be connected to the scan line SL. Therefore, the select transistor ST may be turned on or off by a voltage applied to the scan line SL.

The driving transistor DT receives the first power voltage ELVDD, and may be connected to the anode electrode of the OLED device at a second node N2. A gate of the driving transistor DT may be connected to the first node N1, and the storage capacitor Cst may be connected between the first node N1 and the second node N2. When the select transistor ST is turned on by the voltage applied to the scan line SL, a voltage of the first node N1 may be changed by a data voltage applied to the data line DL, and amounts of charges stored in the storage capacitor Cst may be changed. The driving transistor DT may provide the driving current IDT to the OLED device in response to the charges stored in the storage capacitor Cst.

In an embodiment, to adjust brightness of the display panel 210, a level of the first power voltage ELVDD output by the boost converter 220 and/or a level of the second power voltage ELVSS output by the inverting buck-boost converter 230 may be adjusted. For example, to lower the brightness of the display panel 210, an absolute value of the second power voltage ELVSS output from the inverting buck-boost converter 230 may be reduced.

In an embodiment, to adjust the level of the second power voltage ELVSS as described above, the inverting buck-boost converter 230 may provide a DVS function. The controller 240 may increase or decrease the level of the second power voltage ELVSS by adjusting a duty ratio and/or a frequency of a control signal provided to the inverting buck-boost converter 230. As described above, the second power voltage ELVSS may be a negative voltage, unlike the first power voltage ELVDD, and therefore, it can be understood that as the level of the second power voltage ELVSS increases, the absolute value of the second power voltage ELVSS may decrease, and as the level of the second power voltage ELVSS decreases, the absolute value of the second power voltage ELVSS may increase.

As described above, when the DVS function is activated in the inverting buck-boost converter 230 and the level of the second power voltage ELVSS increases or decreases, a sensing current in which a load sensor included in the controller 240 detects the inverting buck-boost converter 230 may be changed. Therefore, the load sensor may incorrectly diagnose that a magnitude of a load connected to the inverting buck-boost converter 230 has changed, and the controller 240 may execute an incorrect control operation based on the incorrect diagnosis.

In an embodiment, to minimize a change in sensing current detected by the load sensor while the level of the second power voltage ELVSS increases or decreases, the controller 240 may generate a compensation current. In an embodiment, the compensation current may correspond to current added to or subtracted from the output terminal of the inverting buck-boost converter 230 while the level of the second power voltage ELVSS changes, and may be reflected in the sensing current. The compensation current may be reflected to the sensing current, the load sensor may be effectively prevented from misdiagnosing a change in load while the level of the second power voltage ELVSS increases or decreases, and operating efficiency, power consumption, or the like, of the display device 200 may be improved.

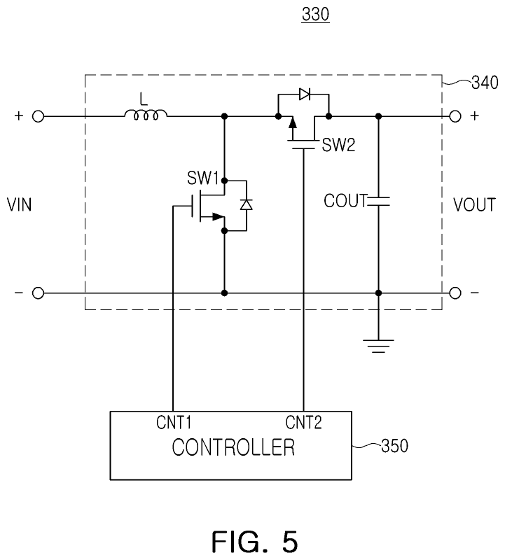

FIGS. 4 to 6 are circuit diagrams illustrating a DC-DC converter included in a power supply device according to an embodiment.

Referring to FIG. 4, a power supply device 300 according to an embodiment may include a DC-DC converter 310 as a voltage conversion circuit, and the DC-DC converter 310 may be an inverting buck-boost converter. For example, the DC-DC converter 310 may be the inverting buck-boost converter 230 of FIG. 2. The inverting buck-boost converter may include first and second switch devices SW1 and SW2, an input capacitor CIN, an output capacitor COUT, an inductor L, and the like. The first switch device SW1 may be connected between the input capacitor CIN and the inductor L, and the second switch device SW2 may be connected between the inductor L and the output capacitor COUT.

A controller 320 may output a first control signal CNT1 controlling on/off switching of the first switch device SW1, and a second control signal CNT2 controlling on/off switching of the second switch device SW2. The first control signal CNT1 and the second control signal CNT2 may have a complementary relationship with each other. Therefore, when the first switch device SW1 is turned on, the second switch device SW2 may be turned off, and when the first switch device SW1 is turned off, the second switch device SW2 may be turned on.

The inverting buck-boost converter may generate an output voltage VOUT having a level, higher or lower than a level of an input voltage VIN, and the output voltage VOUT may have a sign, opposite to a sign of the input voltage VIN. For example, energy may be stored in the inductor L by the input voltage VIN, during a time when the first switch device SW1 is turned on and the second switch device SW2 is turned off. During a time when the first switch device SW1 is turned off and the second switch device SW2 is turned on, energy stored in the inductor L may be transferred to an output terminal.

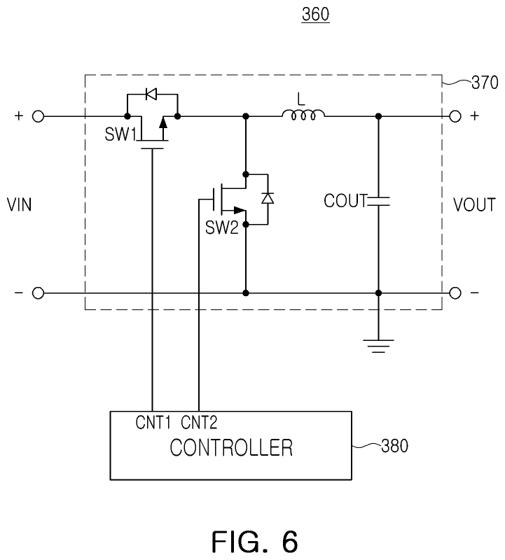

Referring to FIG. 5, a power supply device 330 according to an embodiment may include a DC-DC converter 340 as a voltage conversion circuit, and the DC-DC converter 340 may be a boost converter. For example, the DC-DC converter 340 may be the boost converter 220 of FIG. 2. The boost converter may include first and second switch devices SW1 and SW2, an inductor L, an output capacitor COUT, and the like. The first and second switch devices SW1 and SW2 may be turned on/off by control signals CNT1 and CNT2 output from a controller 350. For example, when the first switch device SW1 is turned on, the second switch device SW2 may be turned off, and when the first switch device SW1 is turned off, the second switch device SW2 may be turned on. The boost converter may generate an output voltage VOUT having a level, higher than a level of an input voltage VIN.

When the first switch device SW1 is turned on, current generated by the input voltage VIN may flow through a loop including the inductor L and the first switch device SW1, and energy may thus be stored in the inductor L. When the first switch device SW1 is turned off and the second switch device SW2 is turned on, current generated by the input voltage VIN may flow through a loop including the second switch device SW2 and the output capacitor COUT, and energy stored in the inductor L may be transferred to an output terminal, the output voltage VOUT on a higher level than the input voltage VIN may be generated.

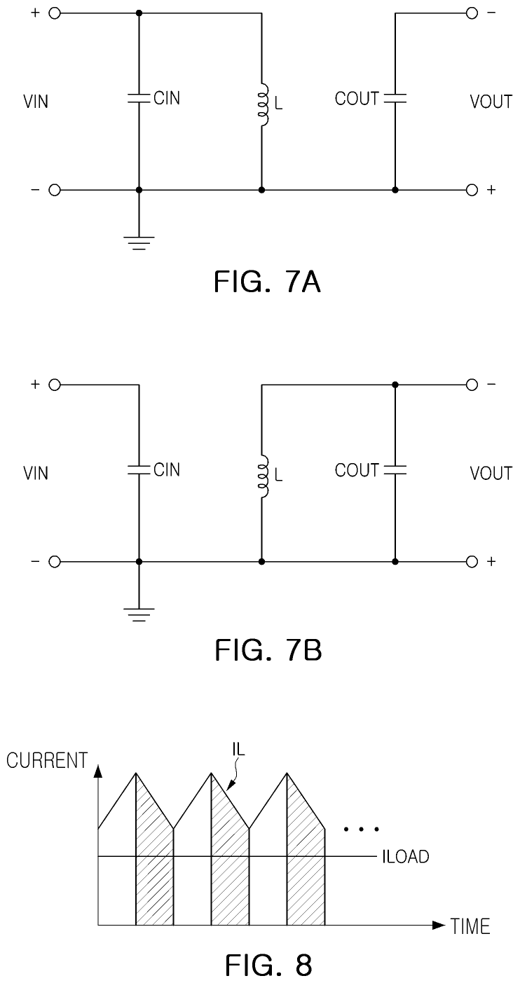

Referring to FIG. 6, a power supply device 360 according to an embodiment may include a DC-DC converter 370 as a voltage conversion circuit, and the DC-DC converter 370 may be a buck converter. For example, the DC-DC converter 370 may be the boost converter 220 of FIG. 2. The buck converter may include first and second switch devices SW1 and SW2, an inductor L, an output capacitor COUT, and the like. Unlike the boost converter previously described with reference to FIG. 5, in the buck converter, the first switch device SW1 may be directly connected to an input terminal. The first and second switch devices SW1 and SW2 may be turned on/off by control signals CNT1 and CNT2 output from a controller 380, and the buck converter may generate an output voltage VOUT having a level, lower than a level of an input voltage VIN. For example, when the first switch device SW1 is turned on, a second switch device SW2 may be turned off, and when the first switch device SW1 is turned off, the second switch device SW2 may be turned on.

When the first switch device SW1 is turned on, current generated by the input voltage VIN may flow through a loop including the first switch device SW1, the inductor L, and the output capacitor COUT, and energy may thus be stored in the inductor L. When the first switch device SW1 is turned off and the second switch device SW2 is turned on, the input terminal may be electrically separated from the inductor L and the output capacitor COUT, and current may flow in a loop including the inductor L, the output capacitor COUT, and the second switch device SW2 by the energy stored in the inductor L. Therefore, the output voltage VOUT may be generated at a lower level than the input voltage VIN.

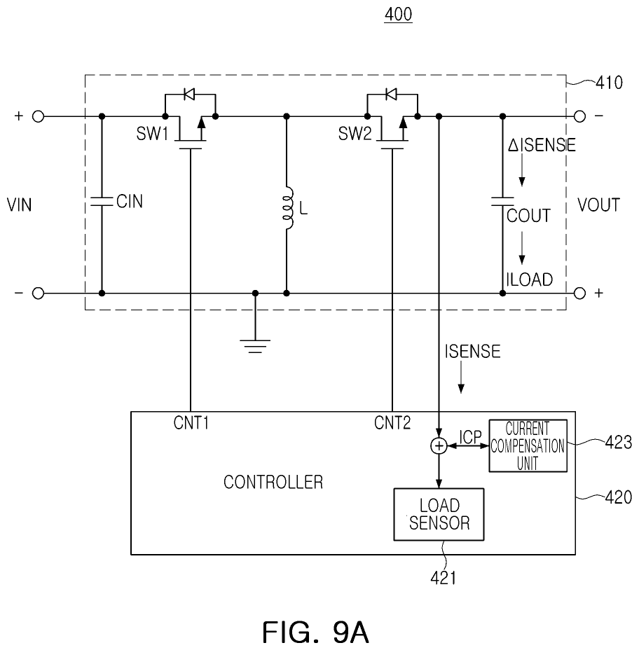

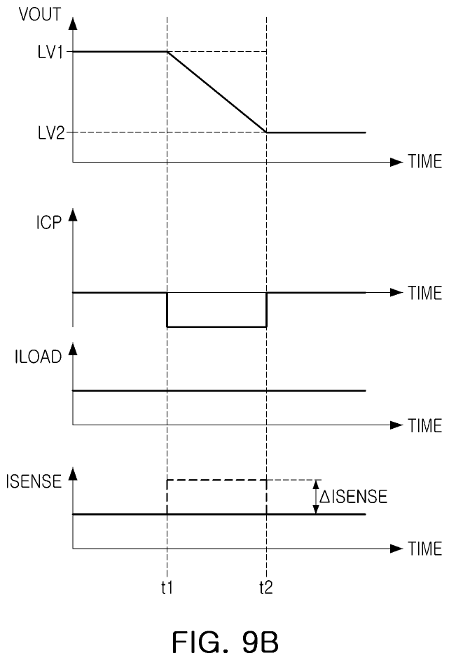

FIGS. 7A and 7B are equivalent circuit diagrams illustrating an operation of a DC-DC converter included in a power supply device according to an embodiment. FIG. 8 is a graph illustrating an operation of a DC-DC converter included in a power supply device according to an embodiment.

FIGS. 7A and 7B may be equivalent circuit diagrams illustrating an operation of the inverting buck-boost converter illustrated in FIG. 4. Referring to FIG. 4 together, FIG. 7A may be an equivalent circuit diagram during a time at which the first switch device SW1 is turned on and the second switch device SW2 is turned off, and FIG. 7B may be an equivalent circuit diagram during a time at which the first switch device SW1 is turned off and the second switch device SW2 is turned on.

Referring to FIGS. 7A and 8, during a time that the first switch device SW1 is turned on, the current may be applied to the inductor L by the input voltage VIN, and the current flowing in the inductor L may linearly increase and energy may be stored in the inductor L. Referring to FIG. 7B, during a time that the second switch device SW2 is turned on, an input terminal may be separated from the inductor L, and the output voltage VOUT may be generated by energy stored in the inductor L. In this case, due to the turned-on second switch device SW2, the output voltage VOUT may be output as an inverted voltage, compared to the input voltage VIN.

As illustrated in FIG. 8, unlike the current flowing in the inductor L increasing and decreasing depending on on/off switching of the switch devices SW1 and SW2, a load current ILOAD may be maintained constant. Even when adjusting a duty ratio and/or a frequency of a control signal applied to each of the switch devices SW1 and SW2 to increase or decrease a level of the output voltage VOUT, the load current ILOAD may be maintained constant.

The controller controlling the switch devices SW1 and SW2 may include the load sensor detecting a sensing current from the inverting buck-boost converter. For example, the load sensor may detect the sensing current from the second switch device SW2 in the inverting buck-boost converter. When the inverting buck-boost converter performs an operation of increasing an absolute value of the output voltage VOUT, additional current may be added to an output capacitor COUT to increase the absolute value of the output voltage VOUT. Therefore, even in the case that there is no change in load actually connected to an output terminal of the inverting buck-boost converter, the sensing current detected by the load sensor may increase.

When the sensing current increases, the controller may determine that the load has increased and execute a control operation corresponding thereto. For example, the controller may respond to a change in load by operating a different DC-DC converter connected to the load, or perform an over-load protection (OLP) operation to prevent circuit damage due to an increase in load. In reality, since there is no change in load, when the controller performs the above control operation, problems such as a meaningless increase in power consumption or unnecessary protection operations may occur.

In an embodiment, while the level of the output voltage VOUT changes, the controller may reflect a separate compensation current to the sensing current. Therefore, even during a transition period when the level of the output voltage VOUT increases or decreases, a change in magnitude of the sensing current detected by the load sensor of the controller may be minimized, and the controller may prevent from executing a control operation of the controller by misdiagnosing an increase in load.

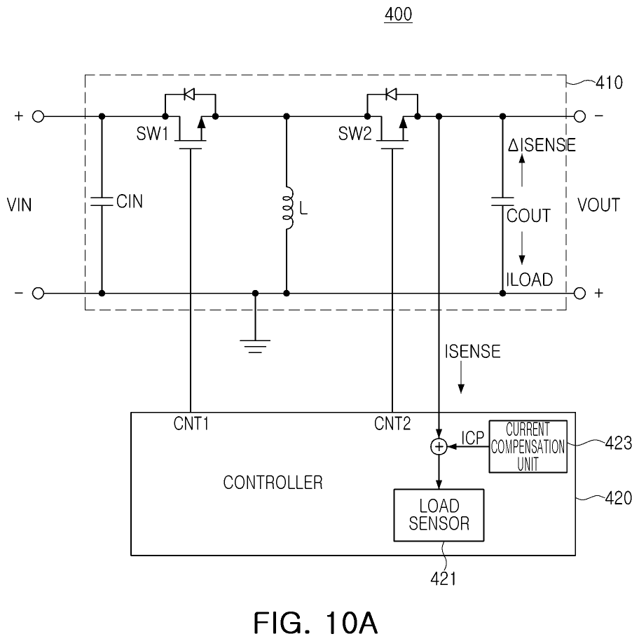

FIGS. 9A and 9B are views illustrating an operation of a power supply device according to an embodiment.

Referring to FIG. 9A, a power supply device 400 according to an embodiment may include a DC-DC converter 410 and a controller 420, and the DC-DC converter 410 may be an inverting buck-boost converter. For example, the DC-DC converter 410 may be the inverting buck-boost converter 230 of FIG. 2. The controller 420 may output a first control signal CNT1 controlling on/off switching of a first switch device SW1, and a second control signal CNT2 controlling on/off switching of a second switch device SW2. Additionally, the controller 420 may detect a sensing current ISENSE, and may generate a compensation current ICP.

FIG. 9B is a view illustrating an operation in which a level of an output voltage VOUT generated from the DC-DC converter 410 decreases from a first level LV1 to a second level LV2. The output voltage VOUT generated from the DC-DC converter 410, which may be an inverting buck-boost converter, may be a negative voltage having a sign, opposite to a sign of an input voltage VIN. Therefore, a decrease in level of the output voltage VOUT may be understood as an increase in absolute value of the output voltage VOUT.

As illustrated in FIG. 9B, during a transition period between a first time point t1 and a second time point t2, the level of the output voltage VOUT decreases from the first level LV1 to the second level LV2. During the transition period, current (e.g., ΔISENSE) may be added to an output capacitor COUT in addition to a load current ILOAD applied before the first time point t1, and thus the absolute value of the output voltage VOUT may increase. For example, when the DVS function is activated, the controller 420 may increase the output current of the DC-DC converter 410 to increase the absolute value of the level of the output voltage VOUT.

Although there is no change in load connected to an output terminal of the DC-DC converter 410, current for increasing the absolute value of the output voltage VOUT may be added to the load current ILOAD, as illustrated in FIG. 9B. As an example, the sensing current ISENSE may increase by an additional current ΔISENSE during the transition period. For example, the absolute value of the output voltage VOUT may increase due to the additional current ΔISENSE added to the sensing current ISENSE during the transition period.

The controller 420 may include a load sensor 421 detecting the sensing current ISENSE, and may control the DC-DC converter 410 with reference to the sensing current ISENSE detected by the load sensor 421. As illustrated in FIG. 9B, when the sensing current ISENSE detected by the load sensor 421 increases during the transition period, the controller 420 may misdiagnose that the load connected to the DC-DC converter 410 has increased. In response to such misdiagnosis, the controller 420 may activate a different DC-DC converter connected to the load in addition to the DC-DC converter 410 or execute an OLP operation. Therefore, power consumption may unnecessarily increase or a meaningless protection operation may be performed.

Referring to FIGS. 9A and 9B, the current compensation unit 423 may generate the compensation current ICP during the transition period, and a magnitude of the compensation current ICP may be equal to a magnitude of the additional current ΔISENSE added during the transition period.

In an embodiment described with reference to FIGS. 9A and 9B, when the DVS function is activated, the additional current ΔISENSE may be added to the output capacitor COUT of the DC-DC converter 410 to increase the absolute value of the output voltage VOUT. Therefore, the controller 420 may subtract the compensation current ICP from the sensing current ISENSE detected from the DC-DC converter 410. In an embodiment illustrated in FIGS. 9A and 9B, the compensation current ICP having substantially the same magnitude as the additional current ΔISENSE may be subtracted from the sensing current ISENSE by the current compensation unit 423.

Therefore, the current input to the load sensor 421 may have the same or similar size as the load current ILOAD, and the load sensor 421 may detect current having approximately the same magnitude as before the first time point t1 even during the transition period. Therefore, the controller 420 may not perform an unnecessary control operation.

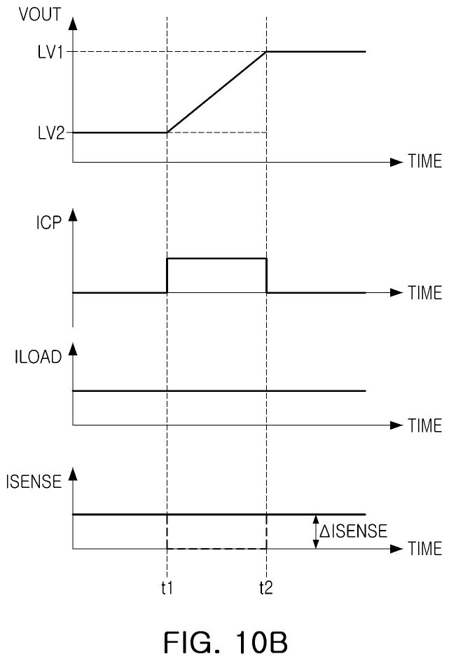

FIGS. 10A and 10B are views illustrating an operation of a power supply device according to an embodiment.

Referring to FIG. 10A, a power supply device 400 according to an embodiment may include a DC-DC converter 410 and a controller 420, and the DC-DC converter 410 may be an inverting buck-boost converter. The controller 420 may output a first control signal CNT1 controlling on/off switching of a first switch device SW1, and a second control signal CNT2 controlling on/off switching of a second switch device SW2. Additionally, the controller 420 may include a load sensor 421 detecting a sensing current ISENSE, a current compensation unit 423 generating a compensation current ICP, and the like.

FIG. 10B is a view illustrating an operation in which a level of an output voltage VOUT generated by the DC-DC converter 410 increases from a first level LV1 to a second level LV2. Both the first level LV1 and the second level LV2 may be negative voltages, and therefore, as the level of the output voltage VOUT increases, an absolute value of the output voltage VOUT may decrease. For example, the DVS function is activated, the controller 420 may decrease the output current of the DC-DC converter 410 to decrease the absolute value of the level of the output voltage VOUT.

As illustrated in FIG. 10B, during a transition period between a first time point t1 and a second time point t2, an output capacitor COUT may subtract an additional current from the load current ILOAD applied before the first time point t1. Therefore, the absolute value of the output voltage VOUT may decrease. Even in the case that there is no change in load connected to an output terminal of the DC-DC converter 410, as the additional current for reducing the absolute value of the output voltage VOUT is subtracted from the load current ILOAD, as illustrated in FIG. 10B, the sensing current ISENSE may be reduced by the additional current ΔISENSE.

As the sensing current ISENSE decreases by the additional current ΔISENSE, the controller 420, which controls the DC-DC converter 410 based on detection results of the load sensor 421, may be misdiagnosed that the load connected to the DC-DC converter 410 has decreased during the transition period. The controller 420 may execute an incorrect control operation in response to such misdiagnosis.

Referring to FIG. 10B, the current compensation unit 423 may generate the compensation current ICP during the transition period, and the compensation current ICP may have the same magnitude as the additional current ΔISENSE subtracted during the transition period.

In an embodiment described with reference to FIGS. 10A and 10B, the compensation current ICP having substantially the same magnitude as the additional current ΔISENSE may be added to the sensing current ISENSE by the current compensation unit 423. In this case, the compensation current ICP may be reflected to the sensing current ISENSE detected from the DC-DC converter 410 by the load sensor 421 to decrease the absolute value of the output voltage VOUT. Therefore, even in the case that the sensing current ISENSE input to the controller 420 is changed by the additional current ΔISENSE during the transition period, current input to the load sensor 421 may remain approximately the same magnitude as before the first time point t1. Therefore, the controller 420 may determine that the load connected to the DC-DC converter 410 has not changed, and may not perform an unnecessary control operation.

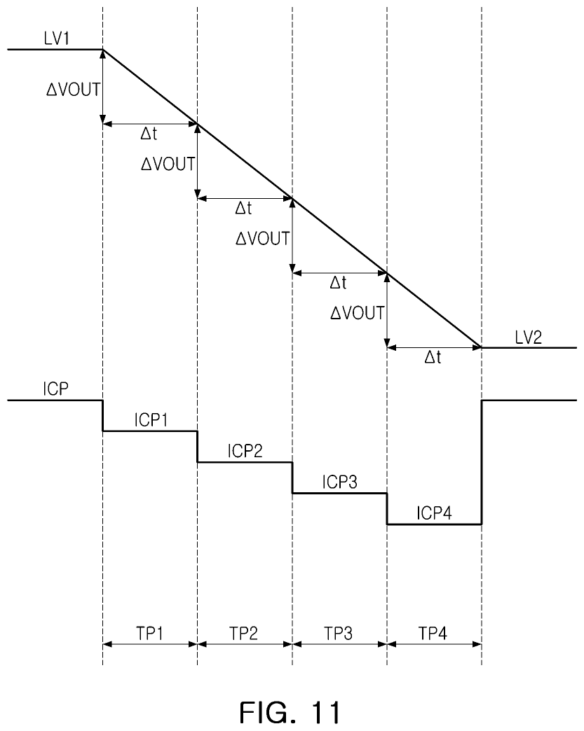

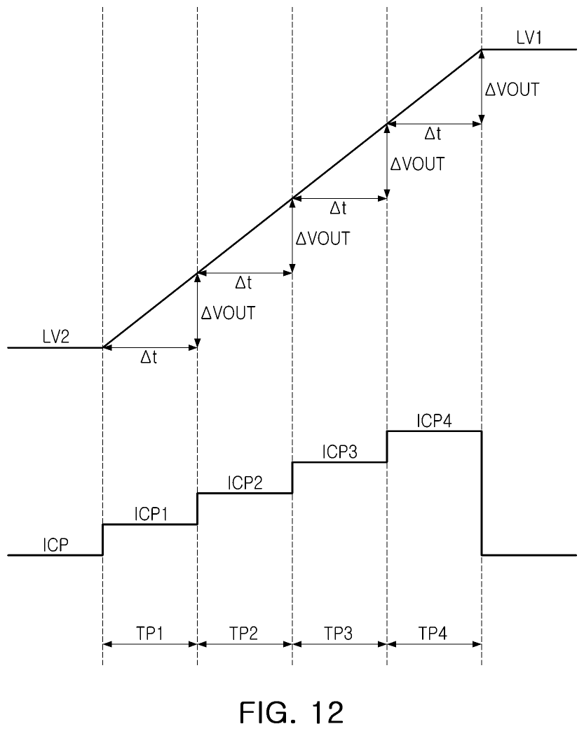

FIGS. 11 and 12 are views illustrating an operation of a power supply device according to an embodiment.

FIGS. 11 and 12 are views illustrating how a controller controlling a DC-DC converter generates a compensation current ICP during a transition period in which an output voltage of the DC-DC converter increases or decreases. In embodiments described with reference to FIGS. 11 and 12, the DC-DC converter may include an inverting buck-boost converter, a buck converter, a boost converter, or the like.

Referring to FIG. 11, a compensation current ICP may be generated during a transition period in which an output voltage decreases from a first level LV1 to a second level LV2. In an embodiment illustrated in FIG. 11, since the output voltage decreases from the first level LV1 to the second level LV2, current may be added to an output capacitor during the transition period. To effectively prevent a malfunction of a controller, it is necessary to calculate an amount of additional current added to the output capacitor, and generate the compensation current ICP based thereon. For example, the additional current reflected in the output capacitor during the transition period may be defined as Equation 1 below:

$${I}_{A D D} = \frac{Δ VOUT * {C}_{EFF}}{Δ t} = Slew rat e * {C}_{EFF} \qquad [ Equation l ]$$

As illustrated in Equation 1, an additional current I_{ADD} reflected in the output capacitor may be determined as the product between a slew rate during the transition period and effective capacitance C_{EFF} of the output capacitor. Therefore, the slew rate may be calculated using the first level LV1, the second level LV2, which may be a length of the transition period, the additional current I_{ADD} may be calculated using effective capacitance C_{EFF} of the output capacitor, and the compensation current ICP may be generated based thereon. For example, effective capacitance C_{EFF} may be determined as a median value of the output voltage, respectively, during sub-periods TP1 to TP4.

In an embodiment, the output capacitor connected to an output terminal of the DC-DC converter may be a multilayer ceramic capacitor (MLCC), and effective capacitance of the multilayer ceramic capacitor may be changed depending on a voltage applied to both ends. Due to such characteristics, when the same compensation current ICP is applied to all periods of the transition period in which the output voltage in the DC-DC converter including the multilayer ceramic capacitor as the output capacitor is changed, a load sensor included in the controller may malfunction.

In an embodiment, as illustrated in FIG. 11, the transition period may be divided into predetermined sub-periods TP1 to TP4, and the controller may generate compensation current ICP having a different magnitude in at least some of the sub-periods TP1 to TP4. In an embodiment illustrated in FIG. 11, a slew rate of each of the sub-periods TP1 to TP4 may be constant, and as previously explained with reference to Equation 1, a magnitude of the additional current added to the output capacitor by effective capacitance of the output capacitor may be determined. Therefore, a magnitude of the compensation current ICP determined according to the additional current may be determined differently in each of the sub-periods TP1 to TP4.

In an embodiment illustrated in FIG. 11, the controller generates a first compensation current ICP1 during a first sub-period TP1, a second compensation current ICP2 during a second sub-period TP2, a third compensation current ICP3 during a third sub-period TP3, and a fourth compensation current ICP4 during a fourth sub-period TP4. Effective capacitance of the output capacitor may be largest in the first sub-period TP1 in which a level of the output voltage is the highest, and may be smallest in the fourth sub-period TP4 in which a level of the output voltage is the lowest. Therefore, among the first to fourth compensation currents ICP1 to ICP4, the first compensation current ICP1 may be generated as the largest, and the fourth compensation current ICP4 may be generated as the smallest.

Referring to FIG. 12, a compensation current ICP may be generated during a transition period in which an output voltage increases from a first level LV1 to a second level LV2. In an embodiment illustrated in FIG. 12, since current flowing in an output capacitor during the transition period may decrease, the output voltage may increase from the first level LV1 to the second level LV2. To effectively prevent a malfunction of a controller, a compensation current ICP corresponding to reduced current in the output capacitor may be generated, and reflected to a sensing current detected by a load sensor of the controller.

A method of determining the compensation current may be similar to that previously described with reference to FIG. 11. For example, a magnitude of the current drawn from the output capacitor to increase the output voltage may be defined as Equation 1 above, and, for example, may be determined by the slew rate of the output voltage and effective capacitance of the output capacitor.

In an embodiment, when the output capacitor connected to the output terminal of the DC-DC converter is a multilayer ceramic capacitor, effective capacitance of the output capacitor may be changed depending on a voltage applied to both ends. Therefore, in an embodiment, as illustrated in FIG. 11, the transition period may be divided into predetermined sub-periods TP1 to TP4, and the controller may generate a compensation current ICP having a different magnitude in at least some of the sub-periods TP1 to TP4, and may reflect the same to the sensing current. In an embodiment illustrated in FIG. 12, a slew rate of each of the sub-periods TP1 to TP4 may be constant, and a magnitude of the compensation current ICP generated in each of the sub-periods TP1 to TP4 may be determined according to effective capacitance of the output capacitor.

In an embodiment illustrated in FIG. 12, effective capacitance of the output capacitor may be smallest in the first sub-period TP1 in which a level of the output voltage is the lowest, and may be largest in the fourth sub-period TP4 in which a level of the output voltage is the highest. Therefore, the controller may generate the first compensation current ICP1 as the smallest and the fourth compensation current ICP4 as the largest, among the first to fourth compensation currents ICP1 to ICP4.

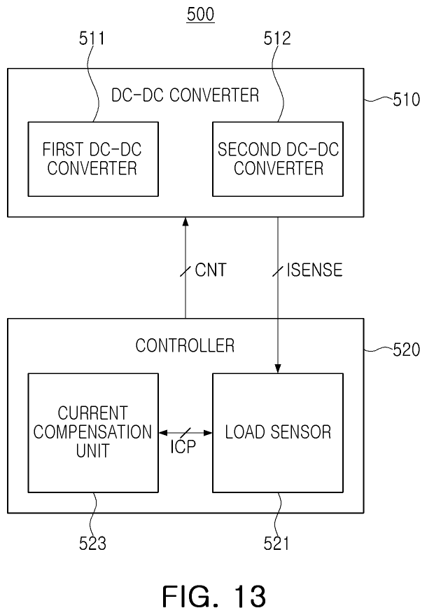

FIG. 13 is a block diagram illustrating a power supply device according to an embodiment.

Referring to FIG. 13, a power supply device 500 according to an embodiment may include a DC-DC converter 510, a controller 520, and the like. The DC-DC converter 510 may include a circuit such as a buck converter, a boost converter, a buck-boost converter, or the like, including at least one switch device. The DC-DC converter 510 may output an output voltage having a level, higher or lower than a level of an input voltage, which may be a direct current voltage. The DC-DC converter 510 may include a first DC-DC converter 511 and a second DC-DC converter 512, and the first DC-DC converter 511 and the second DC-DC converter 512 may be connected to the same load. The first DC-DC converter 511 may be a master converter and the second DC-DC converter 512 may be a slave converter.

The controller 520 may output a control signal CNT controlling on/off switching of the switch device included in the DC-DC converter 510. The control signal CNT may be a pulse width modulated signal, and the level of the output voltage generated by the DC-DC converter 510 may be changed depending on a duty ratio, a frequency, or the like of the control signal CNT.

The controller 520 may include a load sensor 521, a current compensation unit 523, and the like. The load sensor 521 may detect a sensing current ISENSE from the switch device connected to an output terminal of the DC-DC converter 510, and may sense a change in load connected to the output terminal of the DC-DC converter 510, based on the sensing current ISENSE. For example, when a change in load is determined based on the sensing current ISENSE, the controller 520 may execute a control operation corresponding thereto.

In an embodiment, under a situation in which no change in load is detected, the controller 520 may activate the first DC-DC converter 511 and deactivate the second DC-DC converter 512. When only the first DC-DC converter 511 is activated and an increase in load based on the sensing current ISENSE is sensed, the controller 520 may additionally activate the second DC-DC converter 512 to increase an amount of current supplied to a load, and maintain a level of an output voltage applied to the load. Alternatively, the controller 520 may execute an OLP operation in response to an increase in load.

The power supply device 500 may support a DVS function that may adjust a level of the output voltage, regardless of a change in load. For example, the controller 520 may change a duty ratio and/or a frequency of the control signal CNT, to increase or decrease the level of the output voltage of the DC-DC converter 510.

When the DVS function is activated, the output current of DC-DC converter 510 may increase or decrease. As the output current of the DC-DC converter 510 increases or decreases, the sensing current ISENSE detected by the load sensor 521 may change, and therefore even in the case that there is no change in load connected to the DC-DC converter 510, the controller 520 may misdiagnose that the load has changed based on the sensing current ISENSE. Therefore, an unintended malfunction may occur in the power supply device 500.

In an embodiment, during a transition time when the DVS function is activated and the level of the output voltage increases or decreases, the current compensation unit 523 of the controller 520 may provide a compensation current ICP to the load sensor 521 by adding or subtracting the compensation current ICP to or from the sensing current ISENSE. For example, when the DVS function is activated while both the first DC-DC converter 511 and the second DC-DC converter 512 are activated, the current compensation unit 523 may provide the compensation current ICP for the sensing current ISENSE respectively detected in the first DC-DC converter 511 and the second DC-DC converters 512 to the load sensor 521.

The compensation current ICP may be reflected in the sensing current ISENSE that the load sensor 521 detects from the DC-DC converter 510, and may compensate for the sensing current ISENSE that increases or decreases during the DVS function. For example, whether the current compensation unit 523 adds the compensation current ICP to the sensing current ISENSE or draws a portion of the sensing current ISENSE as the compensation current ICP may be determined, depending on an increase or a decrease of the output voltage of the DC-DC converter 510.

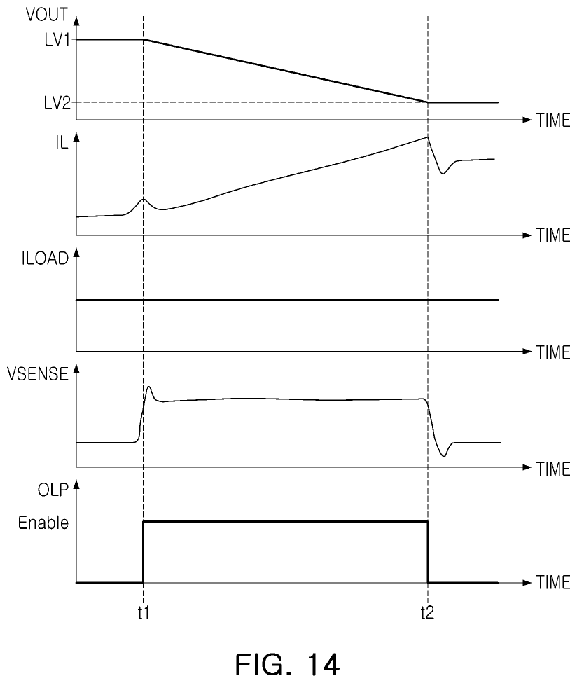

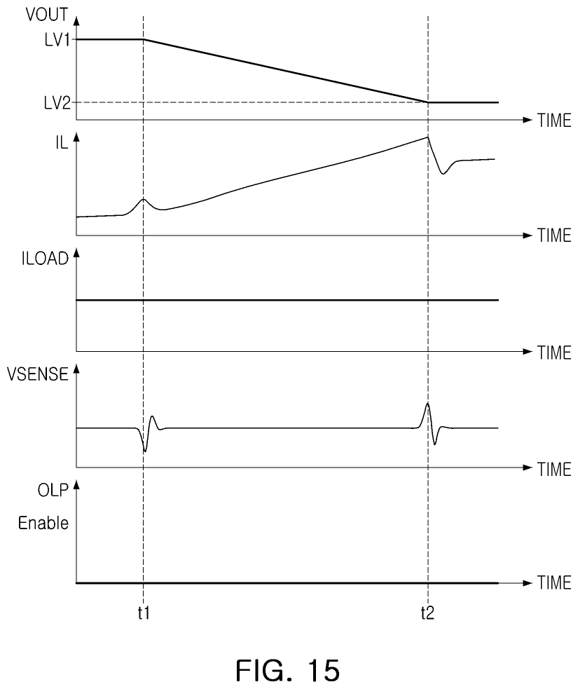

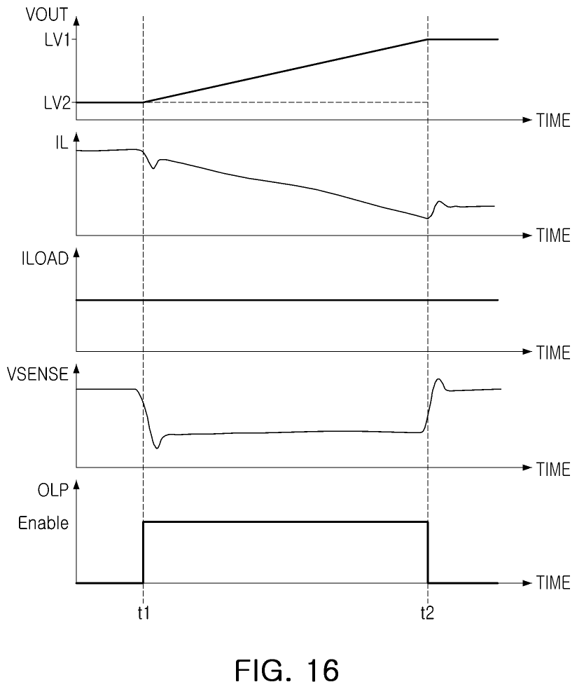

FIGS. 14 and 16 are views illustrating an operation of a power supply device, and FIGS. 15 and 17 to 19 are views illustrating an operation of a power supply device according to example embodiments.

FIGS. 14 and 15 are views illustrating a DVS operation of a power supply device when an output voltage VOUT decreases from a first level LV1 to a second level LV2. The power supply device may include a DC-DC converter, a controller, and the like, and the DC-DC converter may include an inverting buck-boost converter. In this case, the output voltage VOUT of the DC-DC converter may be a negative voltage.

Referring to FIGS. 14 and 15, during a transition period between a first time point t1 and a second time point t2, an output voltage VOUT of a DC-DC converter may be adjusted from a first level LV1 to a second level LV2. Since the output voltage VOUT is a negative voltage, an absolute value of the first level LV1 may be smaller than an absolute value of the second level LV2, and therefore, an inductor current IL flowing in an inductor included in a DC-DC converter may increase, without a change in load connected to an output terminal of the DC-DC converter during the transition period. Since an operation described with reference to FIGS. 14 and 15 is an operation only reducing a level of the output voltage VOUT without a change in load, a load current ILOAD may be maintained constant before and after the transition period.

As described above, a controller may include a load sensor, and the load sensor may detect a sensing current from the DC-DC converter to determine whether the load changes. Referring first to a comparative example illustrated in FIG. 14, at the first time point t1 when a DVS operation is performed, a sensing voltage VSENSE corresponding to the sensing current may increase. This may be a phenomenon that occurs when current is added to an output capacitor in the DVS operation to reduce the output voltage VOUT from the first level LV1 to the second level LV2.

The output voltage VOUT, which may be a negative voltage, decreases from the first level LV1 to the second level LV2 to increase an absolute value of the output voltage VOUT, and current may be added to the output capacitor to increase the absolute value of the output voltage VOUT. The added current may be reflected to the sensing current to increase the sensing current detected by the load sensor, and the sensing voltage VSENSE may increase accordingly. The sensing voltage VSENSE may return to an original value thereof around the second time point t2 when the DVS operation ends.

As a result, even in the case that there is no change in actual load connected to the DC-DC converter, the controller may determine that a load has been added between the first time t1 and the second time t2. Therefore, as illustrated in FIG. 14, an unnecessary protection operation may be performed between the first time t1 and the second time t2 or power consumption of the power supply device may increase.

In an embodiment, a compensation current may be subtracted from a sensing current input to the load sensor of the controller, during a transition period in which the DVS operation is performed. The compensation current may be determined by the current (e.g., ΔISENSE) added to the output capacitor to increase an absolute value of the output voltage VOUT, and, for example, may be determined as described above with reference to FIG. 11. The compensation current may be reflected to the sensing current to minimize a change in sensing current before and after the transition period, and an unnecessary OLP operation (or OLP Enable) or the like may be prevented from being executed.

Referring to FIG. 15 illustrating an operation according to an embodiment, a sensing voltage VSENSE may fluctuate at a first time point t1 and a second time point t2, respectively. This may be a change in sensing voltage VSENSE that occurs when a compensation current is reflected in a sensing current when a DVS operation starts and ends. Except for a phenomenon in which the sensing voltage VSENSE fluctuates at the first time point t1 and the second time point t2, respectively, the sensing voltage VSENSE may be maintained at a constant value, regardless of activation of the DVS operation. Therefore, an unnecessary protection operation may be prevented from being executed even in a transition period to reasonably control the protection operation, and power consumption of a power supply device may be efficiently managed.

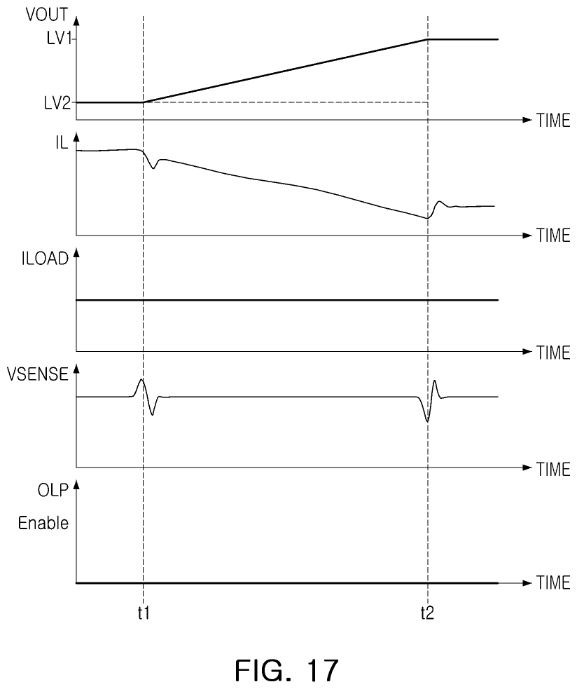

FIGS. 16 and 17 are views illustrating a DVS operation of a power supply device when an output voltage VOUT increases from a second level LV2 to a first level LV1. As previously described with reference to FIGS. 14 and 15, the output voltage VOUT may be a negative voltage, and an absolute value of the second level LV2 may be greater than an absolute value of the first level LV1. Therefore, an inductor current IL flowing in an inductor included in a DC-DC converter may decrease, without a change in load connected to an output terminal of the DC-DC converter during a transition period. Additionally, since an operation described with reference to FIGS. 16 and 17 is an operation only increasing a level of the output voltage VOUT without a change in load, a load current ILOAD may be maintained constant before and after the transition period.

As described above, the controller may include the load sensor detecting the sensing current from the DC-DC converter and determining whether the load changes. Referring first to a comparative example illustrated in FIG. 16, at a first time point t1 when a DVS operation may be performed, a sensing voltage VSENSE corresponding to a sensing current may decrease. This may be a phenomenon that occurs when current flowing through an output capacitor in the DVS operation is reduced to increase the output voltage VOUT from the second level LV2 to the first level LV1.

Due to the reduced current, the sensing current detected by the load sensor decreases, and the sensing voltage VSENSE may decrease accordingly. The sensing voltage VSENSE may return to an original value thereof around a second time point t2 when the DVS operation ends.

Even in the case that there is no change in actual load connected to the DC-DC converter, the controller may determine that the load has decreased between the first time t1 and the second time t2. Therefore, as illustrated in FIG. 14, an unnecessary phase shedding (PSE) operation or the like may be performed between the first time point t1 and the second time point t2, and a problem may occur in an operation of an electronic device using the output voltage VOUT of a power supply device.

In an embodiment, a compensation current may be reflected in the sensing current input to the load sensor of the controller during a transition period in which the DVS operation is performed. The compensation current may be determined by the current subtracted from an output capacitor to reduce an absolute value of the output voltage VOUT, and, for example, may be determined as in an embodiment described above with reference to FIG. 12. The compensation current may be added to the sensing current, a change in sensing current before and after the transition period may be minimized, and an unnecessary phase shedding operation or the like may be prevented from being performed.

Referring to FIG. 17 illustrating an operation according to an embodiment, a sensing voltage VSENSE may fluctuate at the first time point t1 and the second time point t2, respectively. This may be a change in sensing voltage VSENSE that occurs when a compensation current is reflected in a sensing current when a DVS operation starts and ends. Except for a phenomenon in which the sensing voltage VSENSE fluctuates at the first time point t1 and the second time point t2, respectively, the sensing voltage VSENSE may be maintained at a constant value, regardless of activation of the DVS operation. Therefore, the controller may not incorrectly recognize that a load has changed in a transition period, and a phase shedding operation may not be performed during the transition period.

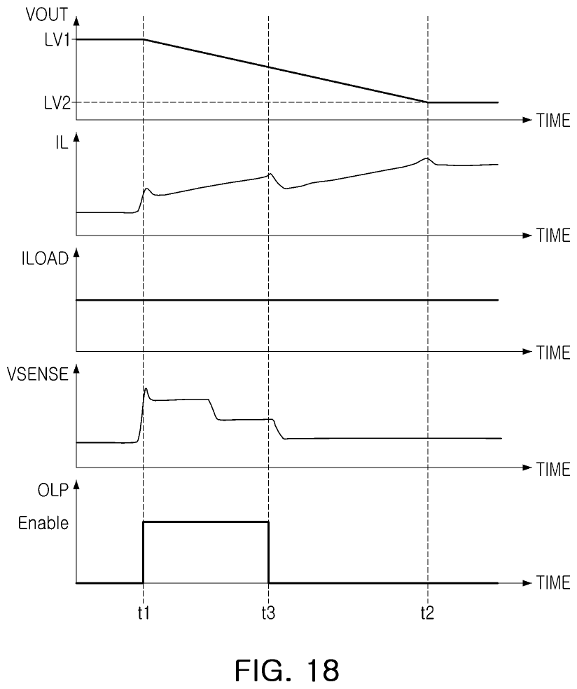

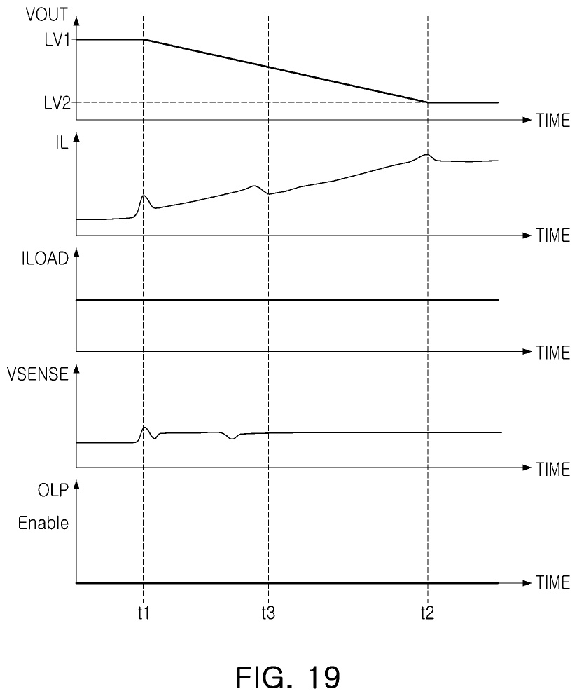

FIGS. 18 and 19 are views illustrating a DVS operation of a power supply device when an output voltage VOUT decreases from a first level LV1 to a second level LV2. The power supply device may include a DC-DC converter, a controller, and the like, and the DC-DC converter may include an inverting buck-boost converter. Therefore, the output voltage VOUT may be a negative voltage.

Referring to FIGS. 18 and 19, an output voltage VOUT of the DC-DC converter may be adjusted from a first level LV1 to a second level LV2 during a transition period between a first time point t1 and a second time point t2. Since the output voltage VOUT is a negative voltage, an absolute value of the first level LV1 may be smaller than an absolute value of the second level LV2, and therefore, an inductor current IL flowing in an inductor included in the DC-DC converter may increase. A load current ILOAD may be maintained constant before and after the transition period.

FIG. 18 is a view illustrating an operation in which a controller generates a constant compensation current and reflects the same to a sensing current during a transition period. As in the embodiments previously described with reference to FIGS. 11 and 12, FIG. 19 is a view illustrating an operation in which a transition period is divided into a plurality of sub-periods and generates a compensation current having a different magnitude in at least some of the sub-periods to reflect the same to a sensing current.

When a certain amount of compensation current is reflected to a sensing current throughout a transition period, an increase in sensing current may not be completely compensated in an initial period of the transition period in which effective capacitance of an output capacitor has a relatively large value. Therefore, in the initial period of the transition period, even in the case that the compensation current is reflected to the sensing current, the sensing current detected by the load sensor may be larger than before the first time point t1, and therefore, as illustrated in FIG. 18, a sensing voltage VSENSE may increase to execute unnecessarily an OLP operation (or OLP Enable) or the like.

When a transition period is divided into two or more sub-periods and a compensation current having a different magnitude in each of the sub-periods to reflect the same to a sensing current, a range of change in sensing voltage VSENSE, as illustrated in FIG. 19, may be reduced compared to the embodiment illustrated in FIG. 18. Therefore, even when the transition period for executing the DVS operation is long or a difference between the first level LV1 and the second level LV2 is large, the transition period may be segmented, and the compensation current having a different magnitude may be reflected to the sensing current, to effectively prevent execution of an unnecessary OLP operation or the like.

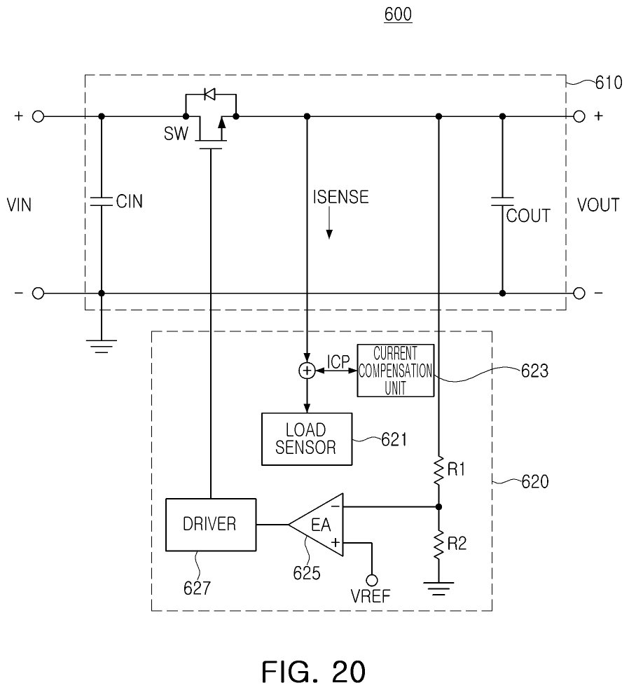

FIG. 20 is a view illustrating a power supply device according to an embodiment.

A power supply device 600 according to an embodiment illustrated in FIG. 20 may include a low drop out (LDO) regulator 610 as a voltage conversion circuit. The power supply device 600 may include the LDO regulator 610 and a controller 620. The controller 620 may include resistor devices R1 and R2, a load sensor 621, a current compensation unit 623, an error amplifier 625, a driver 627, and the like, connected to an output terminal of the LDO regulator 610. The LDO regulator 610 may include an input capacitor CIN, a switch device SW, and an output capacitor COUT, and on/off switching of the switch device SW may be controlled by the driver 627 of the controller 620.

The LDO regulator 610 may generate an output voltage VOUT having a level, lower than a level of an input voltage VIN. The resistor devices R1 and R2 may send a feedback voltage distributed by the output voltage VOUT of the LDO regulator 610 to the error amplifier 625, and the error amplifier 625 may amplify a difference between the feedback voltage and a reference voltage VREF, the driver 627 may control the switch device SW according to an output of the error amplifier 625.

For example, when the input voltage VIN input to the LDO regulator 610 unintentionally increases, the output of the error amplifier 625 may increase. The driver 627 may control the switch device SW in response to an increase in output of the LDO regulator 610, to minimize an increase in output voltage VOUT and stabilize the output voltage VOUT.

The controller 620 may include the load sensor 621 detecting a sensing current from the switch device SW, and may support a DVS function adjusting the level of the output voltage VOUT. When the DVS function is activated, a magnitude of the sensing current detected by the load sensor 621 may be changed even in the case that there is no change in load connected to the output terminal of the LDO regulator 610. Therefore, the controller 620 may incorrectly determine that the load has changed, to additionally execute an unnecessary operation.

In an embodiment, during a transition period in which the DVS function is activated and the level of the output voltage VOUT increases or decreases, the current compensation unit 623 may generate a compensation current ICP to reflect the same to the sensing current ISENSE. For example, when the DVS function is activated and the sensing current ISENSE increases, the compensation current ICP may be subtracted from the sensing current ISENSE, and when the DVS function is activated and the sensing current ISENSE decreases, the compensation current ICP may be added to the sensing current ISENSE. Therefore, it is possible to prevent the controller 620 from incorrectly detecting a change in load during the transition period, and prevent an unnecessary protection operation from being performed or power consumption of the power supply device 600 from increasing.

According to an embodiment, during a transition period in which an output voltage of a voltage conversion circuit included in a power supply device increases or decreases, a compensation current may be reflected to a sensing current detected by a load sensor of a controller controlling the voltage conversion circuit. Therefore, it is possible to effectively prevent a malfunction of the power supply device that may occur due to incorrect detection of a change in load by the load sensor in the transition period in which the output voltage increases or decreases without a change in actual load.

Various advantages and effects of the present inventive concept are not limited to the above-described contents, and can be more easily understood through description of specific embodiments of the present inventive concept.

While example embodiments have been illustrated and described above, it will be apparent to those skilled in the art that modifications and variations could be made without departing from the scope of the present invention as defined by the appended claims.

What is claimed is:

1. A power supply device comprising:
a voltage conversion circuit including at least one switch device configured to operate in response to a control signal, and the voltage conversion circuit configured to:
receive an input voltage, and
generate an output voltage, higher or lower than the input voltage, depending on a duty ratio of the control signal; and
a controller configured to change the duty ratio of the control signal to adjust a level of the output voltage, the controller including:
a load sensor configured to detect a sensing current from the at least one switch device, and
a current compensation unit configured to apply a compensation current to the sensing current input to the load sensor during a transition period in which the output voltage changes from a first level to a second level.

2. The power supply device of claim 1, wherein the voltage conversion circuit includes:
a first DC-DC converter configured to operate as a master device, and
a second DC-DC converter configured to operate as a slave device, and
wherein an activation state of the first DC-DC converter and an activation state of the second DC-DC converter while the output voltage of the first level is output are equal to an activation state of the first DC-DC converter and an activation state of the second DC-DC converter during the transition period, respectively.

3. The power supply device of claim 1, wherein, when an absolute value of the first level is smaller than an absolute value of the second level, the power supply device is configured such that the controller subtracts the compensation current from the sensing current during the transition period.

4. The power supply device of claim 1, wherein, when an absolute value of the first level is greater than an absolute value of the second level, the power supply device is configured such that the controller adds the compensation current to the sensing current during the transition period.

5. The power supply device of claim 1, wherein the voltage conversion circuit includes:
an output capacitor connected to an output terminal of the voltage conversion circuit, and the output capacitor including a multilayer ceramic capacitor.

6. The power supply device of claim 5, wherein the transition period includes a plurality of sub-periods, and
wherein the power supply device is configured such that the controller applies:
a first compensation current to the sensing current in a first sub-period of the plurality of sub-periods, and
a second compensation current of a magnitude, different from a magnitude of the first compensation current, to the sensing current in a second sub-period of the plurality of sub-periods after the first sub-period.

7. The power supply device of claim 6, wherein, when an absolute value of the first level is smaller than an absolute value of the second level, the power supply device is configured such that the controller sets the magnitude of the first compensation current greater than the magnitude of the second compensation current.

8. The power supply device of claim 6, wherein, when an absolute value of the first level is greater than an absolute value of the second level, the power supply device is configured such that the controller sets the magnitude of the first compensation current smaller than the magnitude of the second compensation current.

9. A power supply device comprising:
a voltage conversion circuit including an input terminal, an output terminal, and at least one switch device configured to operate in response to a control signal, and the voltage conversion circuit configured to:
receive an input voltage through the input terminal, and
output an output voltage through the output terminal; and
a controller configured to:
generate the control signal, and
detect a sensing current from the at least one switch device connected to a load connected to the output terminal of the voltage conversion circuit,
wherein the power supply device is configured such that the controller:
generates a compensation current based on a slew rate of the output voltage and effective capacitance of an output capacitor connected to the output terminal of the voltage conversion circuit during a transition period in which a level of the output voltage is adjusted, and
applies the compensation current to the sensing current.

10. The power supply device of claim 9, wherein the power supply device is configured such that the controller subtracts the compensation current from the sensing current when an absolute value of the output voltage increases during the transition period.

11. The power supply device of claim 9, wherein the power supply device is configured such that the controller adds the compensation current to the sensing current when an absolute value of the output voltage decreases during the transition period.

12. The power supply device of claim 9, wherein a magnitude of the compensation current is proportional to the effective capacitance of the output capacitor.

13. The power supply device of claim 9, wherein the transition period includes two or more sub-periods, and
wherein the power supply device is configured such that the controller generates the compensation current having different magnitudes in the sub-periods.

14. The power supply device of claim 13, wherein the magnitudes of the compensation current are determined based on effective capacitance of the output capacitor in each of the sub-periods and the slew rate of the output voltage in each of the sub-periods.

15. The power supply device of claim 14, wherein the effective capacitance of the output capacitor is determined based on a level of the output voltage at an intermediate point in each of the sub-periods.

16. The power supply device of claim 13, wherein the effective capacitance of the output capacitor is changed depending on an absolute value of the output voltage.

17. A power supply device comprising:
a voltage conversion circuit including an inductor, at least one switch device and an output capacitor; and
a controller configured to:
activate the at least one switch device in response to a control signal, and
detect a sensing current from the voltage conversion circuit to determine a change in load receiving an output voltage of the voltage conversion circuit,
wherein the power supply device is configured such that the controller:
subtracts a first compensation current from the sensing current when a current flowing the inductor increases without the change in load, and
adds a second compensation current to the sensing current when the current flowing the inductor decreases without the change in load.

18. The power supply device of claim 17, wherein a magnitude of the first compensation current and a magnitude of the second compensation current are determined based on effective capacitance of the output capacitor.

19. The power supply device of claim 18, wherein each of the magnitude of the first compensation current and the magnitude of the second compensation current is proportional to the effective capacitance of the output capacitor.

20. The power supply device of claim 17, wherein the power supply device is configured such that the controller executes a dynamic voltage scaling (DVS) operation that:
increases an absolute value of the output voltage of the voltage conversion circuit by increasing the current flowing the inductor without the change in load, and
decreases the absolute value of the output voltage of the voltage conversion circuit by decreasing the current flowing the inductor without the change in load.
